(19) United States
(12) Patent Application Publication
(10) Pub. No.: US 2006/0028712 A1
(43) Pub. Date: Feb. 9, 2006

(54) System, method and computer program product for modeling EDFA

(75) Inventors: Tomoko Ohtsuki, Allentown, PA (US); Jutarou Miura, Chiba (JP); Masaru Fukushima, Hiratsuka-shi (JP); Baishi Wang, Somerset, NJ (US)

Correspondence Address: OBLON, SPIVAK, MCCLELLAND, MAIER & NEUSTADT, P.C., 1940 DUKE STREET, ALEXANDRIA, VA, 22314, US

(73) Assignees: FURUKAWA AMERICA, INC, Clinton, NJ (US); OFS FITEL, LLC, Norcross, GA (US)

(21) Appl. No.: 11/124,290

(22) Filed: May 9, 2005

Related U.S. Application Data
(63) Continuation of application No. PCT/US03/35861, filed on Nov. 10, 2003.
(60) Provisional application No. 60/424,707, filed on Nov. 8, 2002.

(51) Int. Cl. H01S 3/00

(52) U.S. Cl. 359/337

(57) ABSTRACT

A system, method and computer program product for determining excited state absorption (ESA) dependent parameters (gain and noise figure) of an EDF and an EDFA corresponding to a determined average inversion value of an EDF. Also, a system, method and computer program product for using an EDFA model that incorporates ESA parameters to in calculating an EDFA gain and noise figure to design laser systems with high accuracy.

### CROSS REFERENCE TO RELATED APPLICATION

The present patent application is related and claims priority to provisional U.S. application 60/424,707 filed on Nov. 8, 2002, the entire contents of which are incorporated herein by reference.

### BACKGROUND OF THE INVENTION

1. Field of Invention

This invention relates to Erbium doped fiber (EDF) and Erbium doped fiber amplifiers (EDFA), and in particular to a method for determining signal excited state absorption (ESA) parameters of an EDF; a method of modeling an EDFA to design EDFAs for WDM applications; and a method for modeling an EDFA that incorporates signal ESA parameters.

2. Description of the Background Art

EDFAs are designed to meet requirements such as output power, gain and noise figure as a function of wavelength for a variety of applications in the field of optical communications. An example of an EDFA is shown in FIG. 1 where C1 is an input connection, W1 is a first wave division multiplexer, LD1 is a first laser diode pump operating at 1480 nm, EDF1 is a first erbium-doped fiber, I1 is an isolator, EDF2 is a second erbium-doped fiber, LD2 is a second laser diode pump operating at 1480 nm, W2 is a second wave division multiplexer, and C2 is an output connection. Isolator I1 minimizes the effects of the backward propagation of amplified spontaneous emission (ASE) into EDF1 from EDF 2. Similarly, the lengths of EDF 1 and EDF 2 are determined so that the backward ASE within EDF1 is insignificant compared to the signal power. For example, the lengths of EDF 1 and EDF 2 are selected so the backward ASE is approximately one order of magnitude less than the signal power.

The EDFA of FIG. 1 between and including connections C1 and C2 is characterized by an overall gain and a noise figure. The overall gain and noise figure comprise the gain and noise figure of the various components of the EDFA. These gain and noise figure parameters of EDF1 and EDF2 vary according to wavelength, erbium content, and physical phenomenology associated with the transmission of the light signal. It is possible design an EDFA by adjusting the lengths of EDF1 and/or EDF2, assuming a predetermined EDF gain and noise figure. Conversely, it is possible to design a gain and noise figure for EDF1 and/or EDF2, assuming a predetermined EDFA gain and noise figure.

To design an overall system with specific gain and noise figure characteristics, expected gain and noise figure values are estimated with the use of various models. The more closely the estimated gain and noise figure values correspond to actual, measured gain and noise figure values, the more accurate and therefore useful the model. Giles model (as described in C. R. Giles, “Modeling Erbium-Doped Fiber Amplifiers,” J. Lightwave Technol., 9, p. 271 (1991), the entire contents of which is incorporated herein by reference) is widely used to model gain and noise figure of EDFAs and to optimize designs of EDFAs where accurate calculation of gain and noise figure of EDFAs is required. The Giles model describes signal power, Psignal, and the power of amplified spontaneous emission (ASE), PASE, with the following rate equations, where, + and − in the following equations denote the forward and the backward propagations, respectively:

$$\begin{matrix}\frac{ⅆ {P}_{signal}^{\pm } ( λ , z )}{ⅆ z} = \pm ( α ( λ ) + {g}^{*} ( λ ) ) \frac{\overline{{n}_{2}} ( z )}{{n}_{t} ( z )} {P}_{signal}^{\pm } ( λ , z ) ∓ ( α ( λ ) + l ( λ ) ) {P}_{signal}^{\pm } ( λ , z ) & ( 1 ) \\ \frac{ⅆ {P}_{ASE}^{\pm } ( λ , z )}{ⅆ z} = \pm ( α ( λ ) + {g}^{*} ( λ ) ) \frac{\overline{{n}_{2}} ( z )}{{n}_{t} ( z )} {P}_{ASE}^{\pm } ( λ , z ) ∓ ( α ( λ ) + l ( λ ) ) {P}_{ASE}^{\pm } ( λ , z ) \pm 2 {g}^{*} ( λ ) \frac{\overline{{n}_{2}} ( z )}{{n}_{t} ( z )} h {ν}_{ASE} Δ {ν}_{ASE} & ( 2 )\end{matrix}$$

α(λ): absorption coefficient
g*(λ): gain (emission) coefficient
\overline{n₂}(z): erbium ion density at the metastable state
nₜ(z): erbium ion density
l(λ): background loss of the fiber

However the general Giles model is not able to accurately estimate gain and noise figure of EDFAs or EDFs where the effects of excited state absorption (ESA) are significant. ESA is absorption from an excited state of erbium to a higher energy level. ESA degrades pump efficiency, gain, and noise figure. An example of the applications where the ESA effect is significant is the L-band EDFA, where the signal wavelength is longer than 1560 nm. The signal ESA effects, which originate from the transition from ⁴I_{13/2} to ⁴I_{9/2}, are shown in FIG. 2. This effect is conventionally modeled by substituting g*(λ) in Eq. (1) (2), with effective gain coefficient g*(λ)′ given as;
g*(λ)′=g*(λ)−α_{ESA}(λ) (3)
α_{ESA}(λ): excited state absorption coefficient

The ESA coefficient, α_{ESA}(λ), typically has a value of <0.5 dB/m at wavelengths of interest. In wavelengths where ESA effects are prominent, α_{ESA}(λ), should be determined so the model can predict gain accuracy greater than (i.e., more accurate than) 0.1 dB/m. In conventional models, α_{ESA}^{MC}(λ) is derived from the McCumber theory (as described in E. Desurvire, “Erbium-Doped Fiber Amplifiers, Principles and Applications,” Wiley-Interscience, p 277 (1994), hereinafter Desurvire, the entire contents of which are incorporated by reference).

FIGS. 3a and 3b show the calculated gain and noise figure of the EDFA with the configuration shown in FIG. 1, using the conventional model described by equation (1), (2) and (3) where all terms g*(λ) of Equations 1 and 2 are replaced with g*(x)′ of Equation (3) and where α_{ESA}(λ) is determined via McCumber theory. For the configuration of FIG. 1, the wavelength dependent values of α_{ESA}(λ) determined via McCumber theory are shown in FIG. 4. In FIGS. 3a and 3b, the input power is 2.5 dBm, LDF1 operates at 100 mW, LDF2 operates at 80 mW, the operating temperature is 65° C., the length of EDF 1 is 7 m, and the length of EDF 2 is 26.2 m. The operating temperatures may be maintained with a heater. The measured gain and noise figure are shown in the same graph as a comparison to the model gain and noise figure. Because the conventional models assume an α_{ESA}(λ) determined via the conventional McCumber method, the conventional models are characterized by large discrepancies between calculated and measured values of gain and noise figure. Therefore, the conventional models are sub-optimal predictors of actual system performance.

Thus, what is required, as recognized by the present inventors, is a method for accurately determining α_{ESA}(λ) and for determining gain and noise figure characteristics of EDFs and EDFAs, whether individually or in combination, where the effects of excited state absorption (ESA) are significant, so as to more efficiently, accurately, and economically build EDFA-based components and systems.

### SUMMARY OF INVENTION

The present invention is directed to a system, method and computer program product for determining ESA parameters of an EDF or an EDFA so as to overcome the above-identified and other limitations associated with conventional systems and methods. The present invention is also directed to a system, method and computer program product for modeling EDFA gain and noise figure with high accuracy by taking into account ESA effects.

### BRIEF DESCRIPTION OF THE DRAWINGS

A more complete appreciation of the present invention and many of the attendant advantages thereof will be readily obtained as the same becomes better understood by reference to the following detailed descriptions and accompanying drawings:

FIG. 1 is a block diagram of a typical EDFA configuration;

FIG. 2 is graphical depiction of ESA effects;

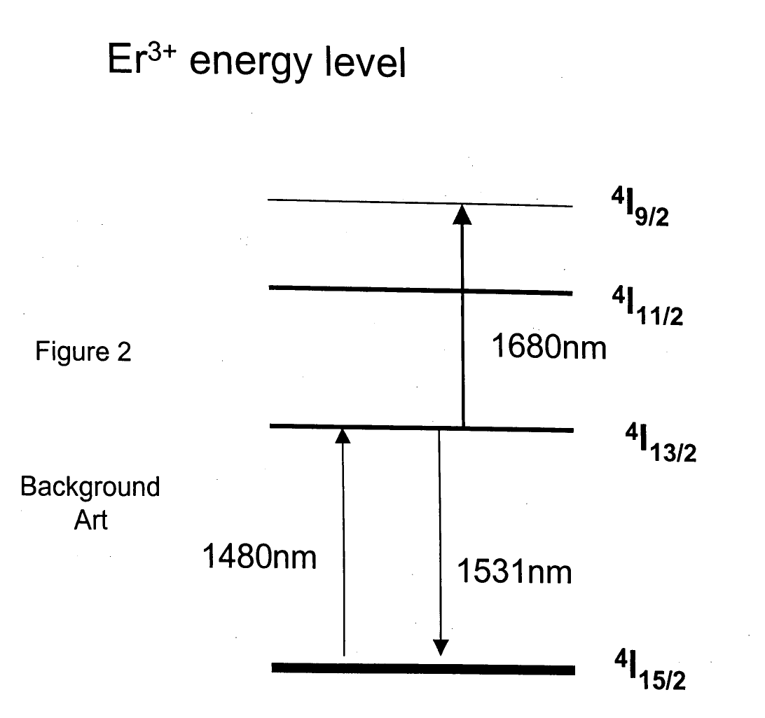

FIGS. 3(a) and 3(b) are graphs of gain and noise figure calculated according to a conventional method;

FIG. 4 is a graph of an ESA coefficient determined according to a conventional method;

FIG. 5 is a graph of parameters calculated according to a conventional method for use in determining ESA effects;

FIG. 6 is a flow chart of a method to determine an ESA coefficient according to an embodiment of the present invention;

FIG. 7 is a block diagram of a system configured to determine an ESA coefficient parameter according to an embodiment of the present invention;

FIG. 8 is a graph comparing values for an ESA coefficient determined according to an embodiment of the present invention with the graph of FIG. 5;

FIGS. 9(a) and 7(b) are graphs of EDFA gain and noise figure calculated according to an embodiment of the present invention under a first operating condition;

FIGS. 10(a) and 8(b) are graphs of EDFA gain and noise figure calculated according to an embodiment of the present invention under a second operating condition; and

FIG. 11 is a block diagram of a computer associated with the present invention.

### DETAILED DESCRIPTION OF THE INVENTION

In order to design an EDFA or an EDF to be used when ESA effects are prominent, one embodiment of the present invention is a method for accurately predicting an ESA parameter so that the actual values of system gain and noise figure are more reliably predicted before production. In wavelengths where ESA effects are prominent, α_{ESA}(λ), should be determined so as to produce a gain accuracy greater than (i.e., more accurate than) 0.1 dB/m.

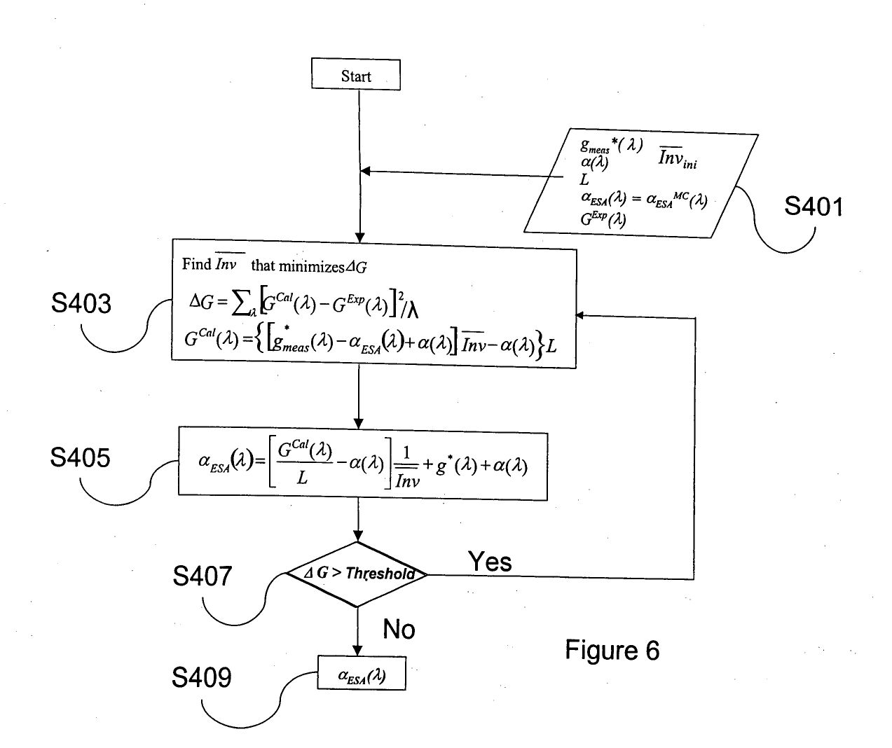

A flow chart of the process used in this method of determining ESA parameter is shown in FIG. 6. First, the gain of an EDFA with Er³⁺ doped fiber EDF) of length L is calculated by an average inversion model in step S403, where
G^{Cal}(λ)={[g*(λ)−α_{ESA}(λ)+α(λ)]\overline{Inv}α(λ)}L (4)
and

$$Inv ( z ) = \frac{{n}_{2} ( z )}{{n}_{t}} \text{:} Inversion ratio$$

$$\overline{Inv} = \frac{1}{L} {\int }_{0}^{L} Inv ( z ) ⅆ z \text{:} Average inversion$$

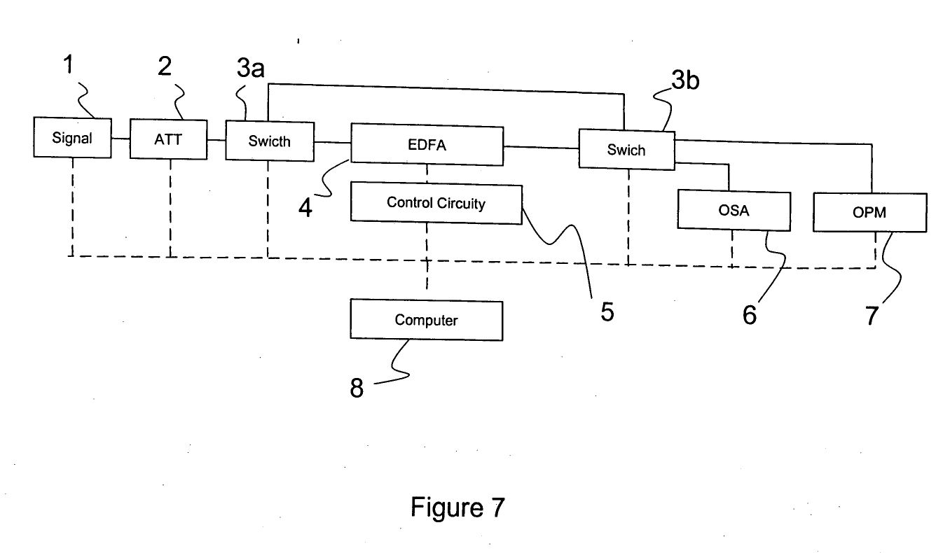

The calculation of Step S403 is based on inputting certain parameters as shown in S401. As an initial value of the ESA coefficient, α_{ESA}^{MC}(λ) is derived via the previously described McCumber theory. The average inversion ratio \overline{Inv} typically used for EDFA is about 0.5 for C-band and 0.3 for L-band. Here The initial average inversion ratio \overline{Inv}ᵢₙᵢ is arbitrarily selected near one of these typical values, depending on the type of EDFA design under test. G^{exp}(λ) is a measured gain determined according to the method described below relative to FIG. 7. L is the length of the EDF in the system for which α_{ESA}(λ) is to be modeled. The fiber parameter g*ₘₑₐₛ(λ) and α(λ) are measured separately from the EDF as taught on page 274 of Desurvire. With these measured values, the gain coefficient, g*(λ), of the average inversion model of equation (4) is determined from g*ₘₑₐₛ(λ) as
g*(λ)=g*ₘₑₐₛ(λ)−α_{ESA}^{MC}(λ). (5)

Using the results of equation (5) in equation (4), the average inversion ratio \overline{Inv} is used to calculate the ESA coefficient α_{ESA}(λ) in step S405 as follows

$${α}_{ESA} ( λ ) = [ \frac{{G}^{Cal} ( λ )}{L} - α ( λ ) ] \frac{1}{\overline{Inv}} + {g}^{*} ( λ ) + α ( λ ) \qquad ( 6 )$$

It should be noted that with this estimation the background loss of a fiber is indistinguishable from the ESA coefficient α_{ESA}(λ). However, treating the fiber background and α_{ESA}(λ) together does not affect the accuracy of subsequent gain and noise figure calculations.

Then a difference ΔG between the calculated gain G^{Cal}(λ) and a measured gain G^{Exp} (λ) is compared in step S407 to a predetermined threshold value. In one embodiment, ΔG is the square of the difference between G^{Cal}(λ) and G^{Exp}(λ) averaged over wavelength. In other embodiments, other ΔG values may be used (e.g., average of the absolute values, etc.) The predetermined threshold is determined based upon the desired gain accuracy. For example, when gain accuracy is desired to be less than (i.e., better than) 0.1 dB, the predetermined threshold may be set equal to 0.05 dB. Therefore, if the difference ΔG is greater than the predetermined threshold, the process iterates using the estimated α_{ESA}(λ) instead of α_{ESA}^{MC}(λ) until the difference is either less than the predetermined threshold or is minimized. When the difference is less than the predetermined threshold or is minimized, the value of α_{ESA}(λ) calculated in the last iteration of Step 405 is output for use as the final value of α_{ESA}(λ) in subsequent rate equation calculations used to estimate the gain and noise figure of associated EDFs.

FIG. 7 shows a block diagram of a system configured to determine an ESA coefficient parameter according the method previously described relative to FIG. 6. The system of FIG. 7 also is configured to determine the value of G^{Exp}(λ) used in the algorithm described in FIG. 6.

The system comprises optical signal source (1), optical attenuator (2), optical switches (3a and 3b), EDFA (4), control circuitry (5), optical spectrum analyzer (6), optical power meter (7), and computer (8). The solid lines in FIG. 7 correspond to an optical signal path. Optical switch (3a) allows the optical signal to be routed through or around EDFA (4), thereby allowing for EDFA input and output signals to be measured. Optical switch (3b) allows the corresponding input or output of EDFA (4) to be sent to either optical spectrum analyzer (6) or optical power meter (7).

The dashed lines in FIG. 7 correspond to an electrical signal line, where the computer (8) controls the signal source (1), optical attenuator (2), optical switches (3a) and (3b), control circuitry (5), optical spectrum analyzer (6), and optical power meter (7). The computer also derives from the measured data the value of G^{Exp}(λ) used as an initial condition in the method of FIG. 6. The computer also executes the calculations shown in the flow chart in FIG. 6 to solve the below-described rate equations. Control circuitry (5) sends electric signals to control the EDFA (4) determined by the output of the computer (8).

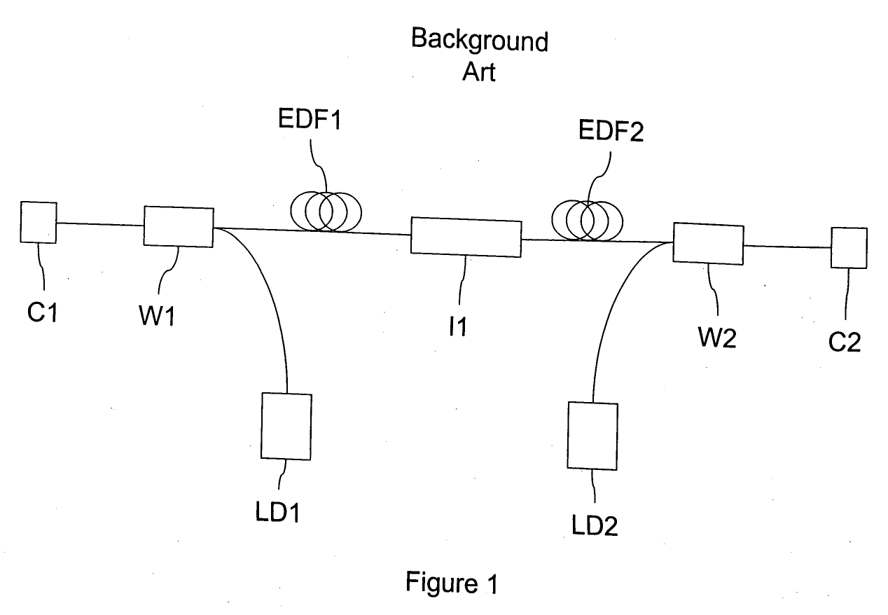

In one embodiment, EDFA (4) is the configuration shown in FIG. 1. In other embodiments, other EDFA configurations may be used. With any EDFA configuration, computer (8) performs the derivation of the G^{Exp}(λ) from the measured data, and performs the calculations of FIG. 6.

Also, for the configuration of FIG. 1, the gain of the total EDFA is known to be somewhere between 10 to 30 dB. The average inversion level is must be between 0.0 and 1.0 is known to be about 0.3, so it is possible to arbitrarily select an initial average inversion level on the order of 0.3 (e.g., 0.35). Also, to achieve the desired EDFA gain, an overall EDF (i.e., EDF1+EDF2) is selected via conventional methods based on known erbium-content, pump power level, etc. length By fixing the length, it is then possible to calculate α_{ESA}(λ) according to FIG. 6. The division of the total length of the EDF between EDF1 and EDF2 is determined to achieve a predetermined sensitivity with respect to the ESA effects. That is, the apportionment of the overall length L between EDF 1 and EDF 2 is determined so the backward ASE is approximately one order of magnitude less than the signal power.

First, measurement of G^{Exp}(λ) is executed according to the following steps. The signal source (1) is connected to the optical power meter (7) through the optical switch (3a) and around EDFA (4), and the optical attenuator (2) is adjusted so that the power level of the signal source (1) becomes a predetermined level Then, second optical switch (3b) is positioned so that the input optical signal is input to the optical spectrum analyzer (6). The optical spectrum analyzer (6) measures the input signal spectrum. Both optical switches (3a and 3b) are then switched in tandem so that the optical signal is input to the EDFA (4) and, simultaneously, the output signal from the EDFA (4) is connected to the optical power meter (7). The computer (8) controls the output signal level of the control circuitry (5) so that the output signal level from the EDFA (4) becomes a predetermined preferred Second optical switch (3b) is then switched so that the output signal from the EDFA (4) is connected to the optical spectrum analyzer (6). The spectrum analyzer (6) measures the output signal spectrum from the EDFA (4). The measured gain, G^{Exp}(λ), is derived from the measured input and output spectrum as described above. That is, G^{Exp}(λ)=10*log(Output power(λ)/Input power(λ)).

Next, the calculations of the algorithm described in FIG. 6 are executed in either computer (8) or another computer. The length of EDF L, gain coefficient g*, and absorption coefficient α, are adopted from the independently measured values of the EDF used in EDFA (4) as described previously. Also, an initial value the ESA parameter is determined as described previously. The computer (8) calculates the gain, G^{Cal}(λ) for a variety of operating conditions.

The computer (8) then executes the flow shown in the FIG. 6, using the obtained G^{exp}(λ), iteratively calculates G^{cal}(λ), ΔG, and α_{ESA}(λ) until ΔG is less than the predetermined threshold or is minimized.

Once α_{ESA}(λ) is calculated for a particular fiber, it is possible to calculate the gain and noise figure of a variety of EDFAs, where the EDFAs vary according to a number of EDFs and/or length of EDFs, and where the EDFs used in these configurations comprise the same material as the fiber for which α_{ESA}(λ) was calculated.

In particular, overall system gain and noise figure for a variety of EDFA configurations may be calculated in a computer according to the following rate equations:

$$\begin{matrix}\frac{ⅆ {P}_{signal}^{\pm } ( λ , z )}{ⅆ z} = \pm ( α ( λ ) + {g}^{*} ( λ ) - {α}_{ESA} ( λ ) ) \frac{\overline{{n}_{2}} ( z )}{{n}_{t} ( z )} {P}_{signal}^{\pm } ( λ , z ) ∓ ( α ( λ ) + l ( λ ) ) {P}_{signal}^{\pm } ( λ , z ) & ( 7 ) \\ \frac{ⅆ {P}_{ASE}^{\pm } ( λ , z )}{ⅆ z} = \pm ( α ( λ ) + {g}^{*} ( λ ) - {a}_{ESA} ( λ ) ) \frac{\overline{{n}_{2}} ( z )}{{n}_{t} ( z )} {P}_{ASE}^{\pm } ( λ , z ) ∓ ( α ( λ ) + l ( λ ) ) {P}_{ASE}^{\pm } ( λ , z ) \pm 2 {g}^{*} ( λ ) \frac{\overline{{n}_{2}} ( z )}{{n}_{t} ( z )} h {ν}_{ASE} Δ {ν}_{ASE} & ( 8 )\end{matrix}$$

Equations (7) and (8) take into account amplified spontaneous emission (ASE) by using the results of Equation (6). Equation (7) corresponds to the combination of conventional Equations (1) and Equation (3), where the term g*(x) of Equation (1) is replaced with the term g*(λ)′ of Equation (3). However, unlike conventional systems where all expressions of g*(λ) in Equation (2) are replaced with the term g*(λ)′ of Equation (3), g*(λ) in the third term of Equation (8) g*(λ) is not replaced with the term g*(λ)′. That is, the third term of Equation (8) includes gain coefficient g*(λ) and does not include α_{ESA}(λ) while the first term in the Equation (8) do include α_{ESA}(λ). This is because the third term in the Equation (8) represents the spontaneous emission from the local excited ions, where no transition associated with ESA effects exists, whereas the first term of Equation (8) describe the amplification of the spontaneous emission through the stimulated emission, where ESA effects do exist. Thus, whereas conventional models either do not account for the ESA effect at all, or overcorrect for the ESA effect, Equation (8) of the present invention properly limits the consideration of ESA effects to just the first term of

$$\frac{ⅆ {P}_{ASE}^{\pm } ( λ , z )}{ⅆ z} .$$

This improved model provides much more accurate estimates of gain and noise figure than the conventional art, as will be seen in the following test results.

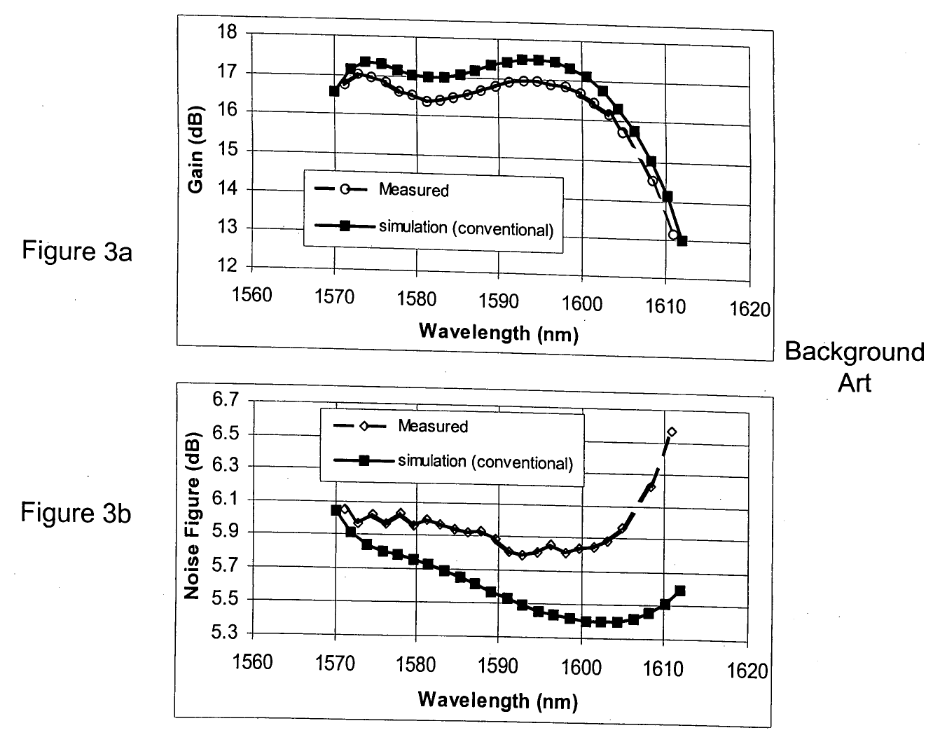

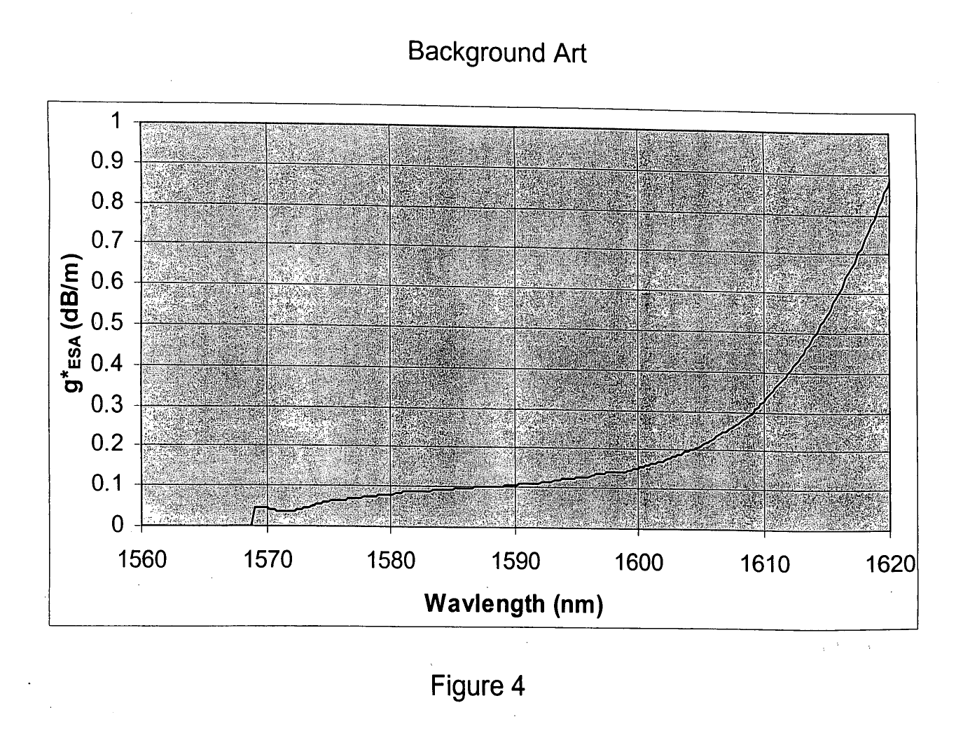

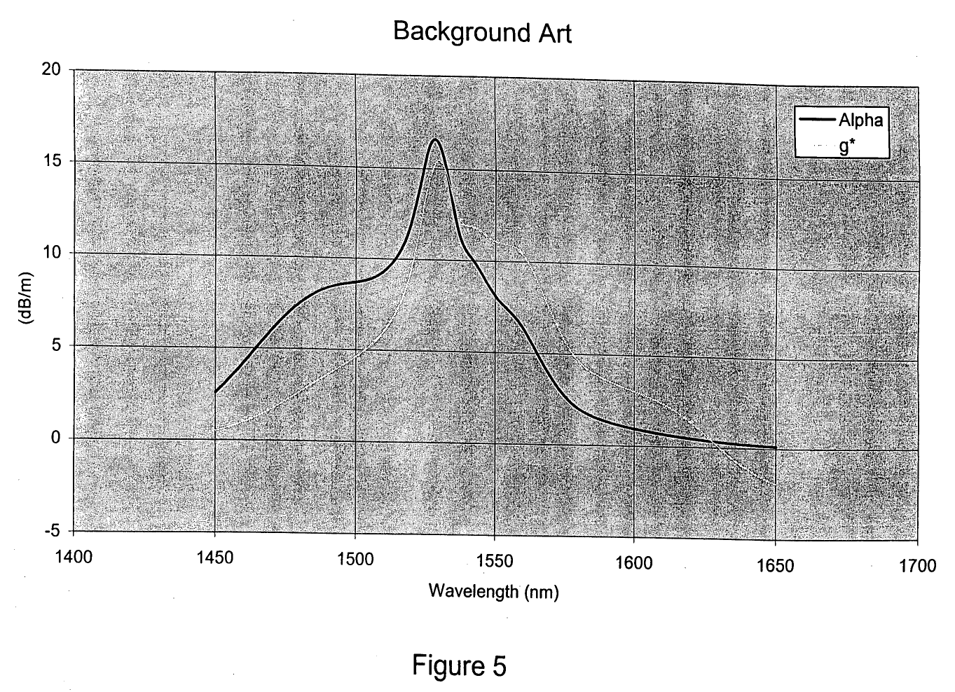

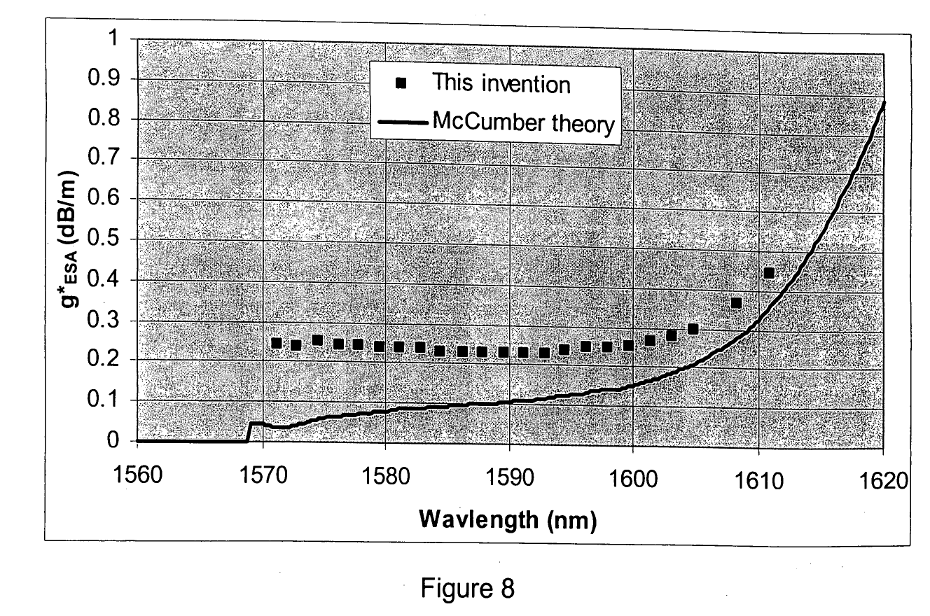

The process of FIG. 6 and the system of FIG. 7 were applied to the configuration of FIG. 1, where once again the input power is 2.5 dBm, LDF1 operates at 100 mW, LDF2 operates at 80 mW, the operating temperature is 65° C., L is 33.2 m (i.e., the sum of the length of EDF1 and EDF2, where the length of EDF 1 is 7 m, and the length of EDF 2 is 26.2 m.) The value of the measured gain G^{exp}(λ) used in the calculation of α_{ESA}(λ) was selected from the values shown in FIG. 3(a) corresponding to the wavelength of interest. Wavelength specific values of g*ₘₑₐₛ(λ) and α(λ) were selected from the graph shown in FIG. 5. Because \overline{Inv} can be between 0 and 1, \overline{Inv}ᵢₙᵢ is arbitrarily selected to be 0.35 and the threshold value is 0.05 dB, corresponding to a desired sensitivity of 0.1 dB. FIG. 8 shows the ESA coefficient α_{ESA}(λ) determined as a function of wavelength according to FIGS. 6 and 7 for the EDFA configuration of FIG. 1. The conventionally calculated values of α_{ESA}(λ) of FIG. 4 are overlaid in FIG. 8 for comparison purposes, indicating that the iterative method of FIG. 6 that takes into account initial measured gain values produces different estimates of α_{ESA}(λ).

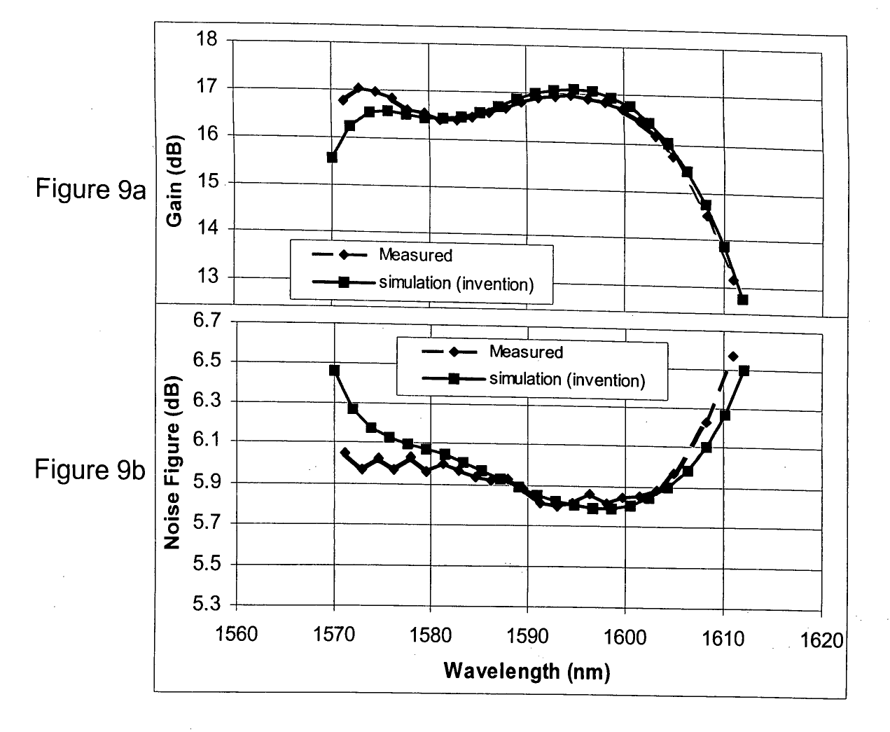

The values of α_{ESA}(λ) calculated in this experiment are then used with Equations (7) and (8) to calculate the gain and noise figures shown in FIGS. 9(a) and 9(b). By comparing FIGS. 9(a) and 9(b) with FIGS. 3(a) and 3(b), it is clear that the present invention's more accurate estimates of α_{ESA}(λ).and more refined rate equations work together to provide much more accurate estimates of gain and noise figure than the conventional art.

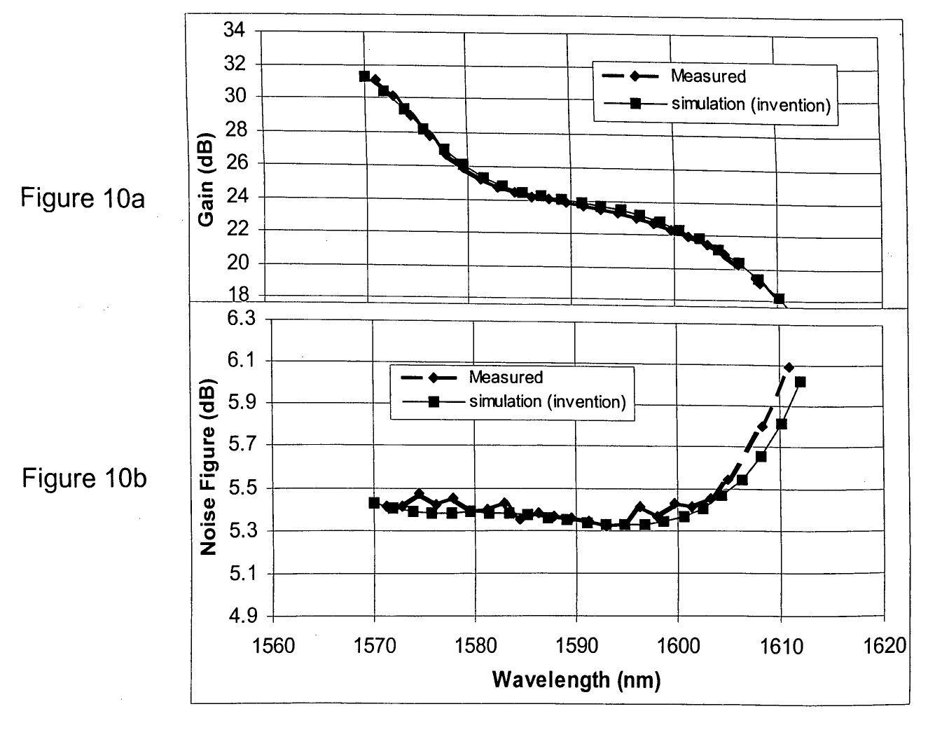

FIGS. 10(a) and 10(b) show EDFA gain and noise figures calculated according to the present invention under conditions different from those shown in FIGS. 3(a) and 3(b). In FIGS. 10(a) and 10(b) the input is −7 dBm, LDF1 operates at 100 mW, LDF2 operates at 80 mW, the operating temperature is 65° C., the length of EDF 1 is 7 m, and the length of EDF 2 is 26.2 m. The measured gain and noise figure are shown in FIGS. 10(a) and 10(b), showing that the present invention provides highly accurate estimates under the different operating conditions as well.

In addition, rate equations (7) and (8 are not limited to modeling EDFAs having EDF lengths the same as the EDF lengths used in calculating α_{ESA}(λ). That is, the rate equations (7) and (8) and the calculated α_{ESA}(λ) may be used to more accurately calculate the gain and noise figures of EDFAs having EDFs which are have a similar material composition as the EDF used in the calculation of α_{ESA}(λ). Gains and noise figures calculated for these different configurations will be more accurate than values calculated via conventional methods, although the degree of accuracy may be less than for the case where the configurations are identical.

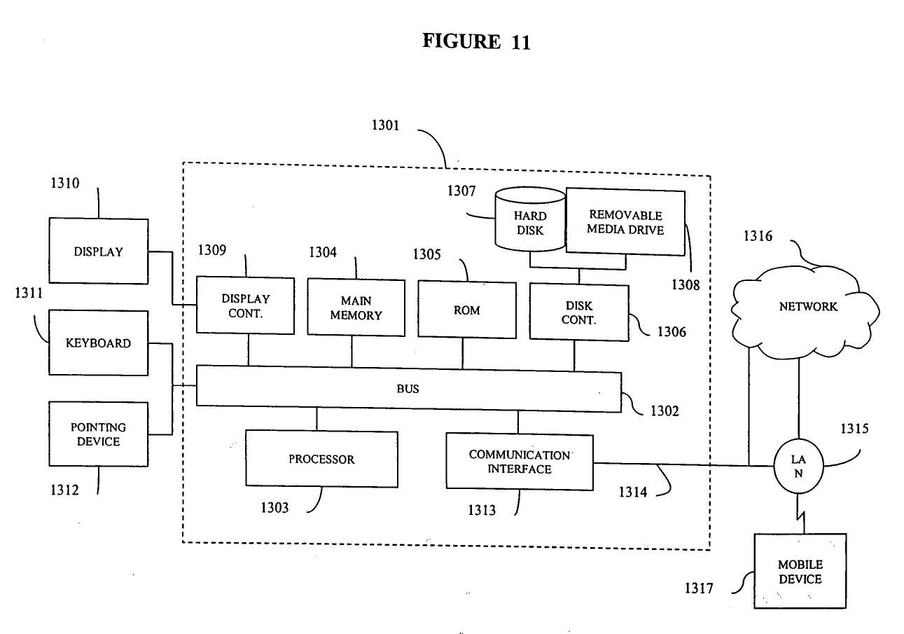

FIG. 11 is a block diagram of a computer system 1301 upon which an embodiment of the present invention may be implemented. Moreover, the computer system 1301 is appropriately programmed to implement the EDFA model discussed herein. The computer system 1301 includes a bus 1302 or other communication mechanism for communicating information, and a processor 1303 coupled with the bus 1302 for processing the information. The computer system 1301 also includes a main memory 1304, such as a random access memory (RAM) or other dynamic storage device (e.g., dynamic RAM (DRAM), static RAM (SRAM), and synchronous DRAM (SDRAM)), coupled to the bus 1302 for storing information and instructions to be executed by processor 1303. In addition, the main memory 1304 may be used for storing temporary variables or other intermediate information during the execution of instructions by the processor 1303. The computer system 1301 further includes a read only memory (ROM) 1305 or other static storage device (e.g., programmable ROM (PROM), erasable PROM (EPROM), and electrically erasable PROM (EEPROM)) coupled to the bus 1302 for storing static information and instructions for the processor 1303.

The computer system 1301 also includes a disk controller 1306 coupled to the bus 1302 to control one or more storage devices for storing information and instructions, such as a magnetic hard disk 1307, and a removable media drive 1308 (e.g., floppy disk drive, read-only compact disc drive, read/write compact disc drive, compact disc jukebox, tape drive, and removable magneto-optical drive). The storage devices may be added to the computer system 1301 using an appropriate device interface (e.g., small computer system interface (SCSI), integrated device electronics (IDE), enhanced-IDE (E-IDE), direct memory access (DMA), or ultra-DMA).

The computer system 1301 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1301 may also include a display controller 1309 coupled to the bus 1302 to control a display 1310, such as a cathode ray tube (CRT), for displaying information to a computer user. The computer system includes input devices, such as a keyboard 1311 and a pointing device 1312, for interacting with a computer user and providing information to the processor 1303. The pointing device 1312, for example, may be a mouse, a trackball, or a pointing stick for communicating direction information and command selections to the processor 1303 and for controlling cursor movement on the display 1310. In addition, a printer may provide printed listings of data stored and/or generated by the computer system 1301.

The computer system 1301 performs a portion or all of the processing steps of the invention in response to the processor 1303 executing one or more sequences of one or more instructions contained in a memory, such as the main memory 1304. Such instructions may be read into the main memory 1304 from another computer readable medium, such as a hard disk 1307 or a removable media drive 1308. One or more processors in a multi-processing arrangement may also be employed to execute the sequences of instructions contained in main memory 1304. In alternative embodiments, hard-wired circuitry may be used in place of or in combination with software instructions. Thus, embodiments are not limited to any specific combination of hardware circuitry and software.

As stated above, the computer system 1301 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1301, for driving a device or devices for implementing the invention, and for enabling the computer system 1301 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1303 for execution. A computer readable medium may take many forms, including but not limited to, non-volatile media, volatile media, and transmission media. Non-volatile media includes, for example, optical, magnetic disks, and magneto-optical disks, such as the hard disk 1307 or the removable media drive 1308. Volatile media includes dynamic memory, such as the main memory 1304. Transmission media includes coaxial cables, copper wire and fiber optics, including the wires that make up the bus 1302. Transmission media also may also take the form of acoustic or light waves, such as those generated during radio wave and infrared data communications.

Various forms of computer readable media may be involved in carrying out one or more sequences of one or more instructions to processor 1303 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1301 may receive the data on the telephone line and use an infrared transmitter to convert the data to an infrared signal. An infrared detector coupled to the bus 1302 can receive the data carried in the infrared signal and place the data on the bus 1302. The bus 1302 carries the data to the main memory 1304, from which the processor 1303 retrieves and executes the instructions. The instructions received by the main memory 1304 may optionally be stored on storage device 1307 or 1308 either before or after execution by processor 1303.

The computer system 1301 also includes a communication interface 1313 coupled to the bus 1302. The communication interface 1313 provides a two-way data communication coupling to a network link 1314 that is connected to, for example, a local area network (LAN) 1315, or to another communications network 1316 such as the Internet. For example, the communication interface 1313 may be a network interface card to attach to any packet switched LAN. As another example, the communication interface 1313 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1313 sends and receives electrical, electromagnetic or optical signals that carry digital data streams representing various types of information.

The network link 1314 typically provides data communication through one or more networks to other data devices. For example, the network link 1314 may provide a connection to another computer through a local network 1315 (e.g., a LAN) or through equipment operated by a service provider, which provides communication services through a communications network 1316. The local network 1314 and the communications network 1316 use, for example, electrical, electromagnetic, or optical signals that carry digital data streams, and the associated physical layer (e.g., CAT 5 cable, coaxial cable, optical fiber, etc). The signals through the various networks and the signals on the network link 1314 and through the communication interface 1313, which carry the digital data to and from the computer system 1301 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1301 can transmit and receive data, including program code, through the network(s) 1315 and 1316, the network link 1314, and the communication interface 1313. Moreover, the network link 1314 may provide a connection through a LAN 1315 to a mobile device 1317 such as a personal digital assistant (PDA) laptop computer, or cellular telephone.

Although this specification discloses applications for the EDF and EDFA, the disclosed method and system are applicable to any type of fiber doped with laser active ions, atom, or molecules. Also, numerous modifications and variations of the present invention are possible in light of the above teachings. It is therefore to be understood that within the scope of the appended claims, the invention may be practiced otherwise than as specifically described herein.

1. A method of determining a wavelength dependent excited state absorption (ESA) parameter of a doped fiber, comprising:
measuring a gain of a doped fiber amplifier to produce a measured gain;
determining a gain of said doped fiber amplifier based on an excited state absorption (ESA) estimate to produce a determined gain;
determining an excited state absorption (ESA) parameter corresponding to said measured gain;
comparing a difference between said measured gain and said determined gain to a predetermined threshold; and one of
outputting said excited state absorption (ESA) parameter if said minimal difference is less than the predetermined threshold or is minimized, and
iteratively determining said gain, determining said excited state absorption (ESA) parameter, and comparing said difference until said difference is less than said predetermined threshold or is minimized,
wherein each iteration is based on an excited state absorption (ESA) parameter determined in a previous iteration, and an excited state absorption (ESA) parameter determined in a final iteration is output.

2. The method of claim 1, wherein said step of determining a gain comprises: determining
G^{Cal}(λ)={[g*(λ)−α_{ESA}(λ)]\overline{Inv}−α(λ)}L

3. The method of claim 1, wherein said step of determining an excited state absorption (ESA) parameter comprises:
$$determining {α}_{ESA} ( λ ) = [ \frac{{G}^{Cal} ( λ )}{L} - α ( λ ) ] \frac{1}{\overline{Inv}} + {g}^{*} ( λ ) + α ( λ )$$

4. The method of claim 1I wherein said step of determining a determined gain comprises:
determining said initial excited state absorption (ESA) estimate according to a McCumber theory.

5. The method of claim 1, wherein said excited state absorption (ESA) parameter includes a background loss characteristic of said doped fiber.

6. The method of claim 1, wherein said doped fiber is an EDF.

7. The method of claim 6, wherein said EDF is configured to operate at a wavelength range equal to or longer than 1560 nm.

8. A system configured to determine a wavelength dependent excited state absorption (ESA) parameter of a doped fiber, comprising:
means for measuring a gain of a doped fiber amplifier to produce a measured gain;
means for determining a gain of said doped fiber amplifier based on an excited state absorption (ESA) estimate to produce a determined gain;
means for determining an excited state absorption (ESA) parameter corresponding to said measured gain;
means for comparing a difference between said measured gain and said determined gain to a predetermined threshold; and
means for outputting said excited state absorption (ESA).

9. The system of claim 8, wherein said means for measuring a gain comprises:
means for outputting signal light;
means for adjusting signal power from said means for outputting signal light to a predetermined signal level;
a doped fiber amplifier containing said doped fiber;
means for measuring signal power provided to the doped fiber amplifier;
means for inputting signal light to the doped fiber amplifier;
means for measuring signal power output from the doped fiber amplifier;
means for controlling said means for outputting signal light, said means for adjusting signal power, said doped fiber amplifier, said means for measuring signal power input to doped fiber amplifier, and said means for measuring signal power output from the doped fiber amplifier; and
means for controlling the control circuit and deriving said measured gain.

10. The system of claim 8, wherein said means for measuring a gain comprises:
a signal source having an output;
an optical attenuator having an attenuator input and output, said attenuator input connected to the signal source output;
a first optical switch having an first switch input, a first switch direct output, and a first switch bypass output, said first switch input connected to said optical attenuator output;
a doped fiber amplifier containing said doped fiber and having a doped fiber amplifier input and a doped fiber amplifier output, said doped fiber amplifier input connected to said first switch direct output;
a second optical switch having as second switch input, an analyzer output, and a power meter output, said second switch input connected to said doped fiber amplifier output;
a optical spectrum analyzer having an analyzer input and output, said analyzer input connected to said second switch analyzer output;
a optical power meter having a power meter input and output, said power meter input connected to said second switch power meter output;
a control circuit connected to and configured to control the signal source, the optical attenuator, the first optical switch, the doped fiber amplifier, the second optical switch, the optical spectrum analyzer, the optical power meter; and
a computer connected to and configured to control the control circuit and to derive said measured gain.

11. The system of claim 10, wherein said computer comprises:
said means for determining a gain;
said means for determining an excited state absorption (ESA) parameter;
said means for comparing; and
said means for outputting said excited state absorption (ESA).

12. The system of claim 10, wherein said doped fiber is an EDF, and said doped fiber amplifier is an EDFA.

13. A method to determine one of a noise figure and a gain of a doped fiber subject to excited state absorption (ESA), comprising:
determining an excited state absorption (ESA) parameter; and
determining a power of amplified spontaneous emission (ASE) PASE, wherein said determining a power of amplified spontaneous emission (ASE) PASE, includes
determining a spontaneous emission from a plurality of local excited ions without said excited state absorption (ESA) parameter,
determining an amplification of spontaneous emission through stimulated emission with said excited state absorption (ESA) parameter.

14. The method of claim 13, wherein said determining a power of amplified spontaneous emission (ASE) PASE comprises:.
determining
$$\frac{ⅆ {P}_{ASE}^{\pm } ( λ , z )}{ⅆ z} = \pm ( α ( λ ) + {g}^{*} ( λ ) - {α}_{ESA} ( λ ) ) \frac{\overline{{n}_{2}} ( z )}{{n}_{t} ( z )} {P}_{ASE}^{\pm } ( λ , z ) ∓ ( α ( λ ) + l ( λ ) ) {P}_{ASE}^{\pm } ( λ , z ) \pm 2 {g}^{*} ( λ ) \frac{\overline{{n}_{2}} ( z )}{{n}_{t} ( z )} h {ν}_{ASE} Δ {ν}_{ASE}$$

15. The method of claim 13, further comprising:
determining a signal power P_{signal}.

16. The method of claim 15, wherein said step of determining a signal power P_{signal} comprises:
determining
$$\frac{ⅆ {P}_{signal}^{\pm } ( λ , z )}{ⅆ z} = \pm ( α ( λ ) + {g}^{*} ( λ ) - {α}_{ESA} ( λ ) ) \frac{\overline{{n}_{2}} ( z )}{{n}_{t} ( z )} {P}_{signal}^{\pm } ( λ , z ) ∓ ( α ( λ ) + l ( λ ) ) {P}_{signal}^{\pm } ( λ , z )$$

17. The method of claim 13, wherein said step of determining an excited state absorption (ESA) parameter comprises:
measuring a gain of a doped fiber amplifier to produce a measured gain;
determining a gain of said doped fiber amplifier based on an excited state absorption (ESA) estimate to produce a determined gain;
determining a determined excited state absorption (ESA) parameter corresponding to said measured gain;
comparing a difference between said measured gain and said determined gain to a predetermined threshold; and one of
outputting said determined excited state absorption (ESA) parameter if said minimal difference is less than the predetermined threshold or is minimized, and
iteratively determining said gain, determining said determining excited state absorption (ESA) parameter, and comparing said difference until said difference is less than said predetermined threshold or is minimized,
wherein each iteration is based on an excited state absorption (ESA) parameter determined in a previous iteration, and an excited state absorption (ESA) parameter determined in a final iteration is output.

18. The method of claim 17, wherein said step of determining a gain comprises:
determining
G_{Cal}(λ)={[g*(λ)−α_{ESA}(λ)+α(λ)]\overline{Inv}−α(λ)}L

19. The method of claim 17, wherein said step of determining an excited state absorption (ESA) parameter comprises:
determining
$${α}_{ESA} ( λ ) = [ \frac{{G}^{Cal} ( λ )}{L} - α ( λ ) ] \frac{1}{\overline{Inv}} + {g}^{*} ( λ ) + α ( λ )$$

20. The method of claim 13, wherein said doped fiber is an EDF.

21. The method of claim 20, wherein said EDF is configured to operate at a wavelength range longer than 1560 nm.

22. A system configured to determine one of a noise figure and a gain of an EDF subject to excited state absorption (ESA), comprising:
means for determining an excited state absorption (ESA) parameter; and
means for determining a power of amplified spontaneous emission (ASE) P_{ASE}, wherein said means for determining a power of amplified spontaneous emission (ASE) P_{ASE}, includes
means for determining a spontaneous emission from a plurality of local excited ions without said excited state absorption (ESA) parameter, and
means for determining an amplification of spontaneous emission through stimulated emission with said excited state absorption (ESA) parameter.

23. The system of claim 22, further comprising:
means for determining a signal power P_{signal}.

24. The system of claim 22, wherein said:means for determining an excited state absorption (ESA) parameter comprises:
means for measuring a gain of a doped fiber amplifier to produce a measured gain;
means for determining a gain of said doped fiber amplifier based on an excited state absorption (ESA) estimate to produce a determined gain;
means for determining an excited state absorption (ESA) parameter corresponding to said measured gain;
means for comparing a difference between said measured gain and said determined gain to a predetermined threshold; and
means for outputting said excited state absorption (ESA).

25. A computer program product configured to host and provide instructions corresponding to any one of the methods of claims 1-7 and 13-21.
